(19) United States
(12) Patent Application Publication
(10) Pub. No.: US 2008/0249756 A1
(43) Pub. Date: Oct. 9, 2008

(54) Method and system for integrating computer aided design and energy simulation

(76) Inventor: Pongsak Chaisuparasmikul, Chicago, IL (US)

Correspondence Address: Douglas H. Pauley;Pauley Petersen & Erickson, Suite 365, 2800 West Higgins Road, Hoffman Estates, IL, 60169, US

(21) Appl. No.: 11/784,333

(22) Filed: Apr. 6, 2007

(51) Int. Cl. G06F 17/50

(52) U.S. Cl. 703/13

(57) ABSTRACT

A software system and method for providing interoperability between computer aided design and energy simulation. The method includes preparing an electronic construction plan, extracting structure information from the electronic construction plan, executing an energy simulation using at least a portion of the structure information, and displaying an energy efficiency analysis of the construction plan through a user interface.

### BACKGROUND OF THE INVENTION

This invention relates generally to the interoperability of building data modeling technology and building performance simulation, and more particularly, provides a link between computer aided design (CAD) and energy performance simulation software.

During the last four decades, building designers have utilized information and communication technologies for creating environmental representations in order to communicate spatial concepts or designs and for enhancing spaces. Most architectural firms still rely on hand labor, working from drafted drawings, generating construction documents, specifications, schedules, and work plans in traditional means. Three-dimensional modeling has been used primarily as a rendering tool, not as the actual representation of the project.

The AEC industry appears to be moving toward adopting building information model (BIM) as the next generation of CAD, and over standard computerized drafting. Already many governments are adopting BIM technology. In the U.S., for example, the General Services Administration and other agencies are embarking on initiatives that will require the use of BIM solutions for work done on their buildings and complexes. BIM is a different and more productive way of working for all AEC professionals, from the architect or designer, through the structural and MEP engineers to the contractor, and finally to the owner.

Building information models, or simply building models, are complete, integrated, digital representations of a project that can be used for many purposes and revenue streams while enabling design professionals to share data. This collaboration between architects, engineers, consultants, contractors, developers, and owners provides mutual benefits from many different aspects of the data, which describe different aspects of building design, concept, aesthetic, function, safety, energy performance, and sustainability. Lack of CAD's interoperability with energy simulation software is a major obstacle that limits the work flow usability, due to difficulty in acquiring information from building geometries, coordinates, climate location, thermal zones, construction and materials properties etc.

The following are characteristics of the building information model: allows for development of architectural detailing routines that support styles of detailing that can be easily customized; allows for development of connection theory, allowing modules ranging from a piece of mechanical equipment to a prefabricated bathroom to be interfaced with the rest of the building; allows for development of new drawing representations to be used by construction and erection crews, eliminating the general purpose, but difficult to read, current standards for construction documents; provides new ways to assess and evaluate buildings, regarding health, flexibility, and other factors; provides new representations that integrate architectural design and the construction process, so that design teams work out how a building is to be constructed as they design it.

It is typical in the traditional design process to recreate the same building model as much as seven or eight times (architecture, structure, mechanical, electrical, plumbing, energy analysis and simulation, construction documents, lighting, code checking, cost estimation, etc.). The largest portion of the effort to prepare building performance simulation input is absorbed by the definition of building geometry, due to the reason that effort to comprehend and extract the pertinent information of two-dimensional drawings to define three-dimensional building geometry is required for simulation. Traditional means of building performance simulation must be improved to level of automation in the acquisition of building geometry. It would be useful if the output data of a CAD drawing can be directly imported into a simulation tool and converted into ready to use graphic interface.

Despite the variety of energy simulation applications in the lifecycle of building design and construction projects, there is a need for a system of data integration to allow sharing and bidirectional reuse of data between CAD software and energy simulation software.

### SUMMARY OF THE INVENTION

A general object of the invention is to provide interoperability between CAD software and energy simulation software.

The general object of the invention can be attained, at least in part, through a method of improving construction design. The method includes preparing an electronic construction plan; extracting structure information from the electronic construction plan; executing an energy simulation using at least a portion of the structure information; and displaying an energy efficiency analysis of the construction plan through a user interface.

The invention further comprehends a method of improving construction design including providing an electronic construction plan; extracting structure information from the electronic construction plan, the structural information including an electronic list of structural components; executing a first energy simulation as a function of at least a portion of the structure components; displaying an energy efficiency analysis from the first energy simulation through a user interface; receiving an alternative structural component through the user interface, wherein the alternative structural component is used as a substitute for at least one structural component of the list of structural components; executing a second energy simulation using the alternative structural component instead of the at least one structural component; and displaying through the user interface a second energy efficiency analysis from the second energy simulation for comparison by a user to the first energy efficiency analysis.

This invention provides a link between CAD, e.g., a building information model, and a computer implemented energy simulation and evaluation. The energy simulation simulates the interventions and responsiveness of climate, the surrounding environment, the building, the occupants, facilities, and other equipment by running iterative “what if” criteria and scenarios for the relationship. The method of this invention includes defining and evaluating the building as an object model representation, the user criteria and profile, and energy systems as an activity or event procedure. The method also includes receiving interfacing input by the user, and evaluating the possible energy efficient alternatives.

With the method and system of this invention, architects and building designers can visually analyze dynamic building energy performance in response to changes of climate and building parameters. The software interoperability provided by this invention provides full data exchange having bidirectional capabilities, which significantly reduces time and effort in energy simulation and data regeneration. Data mapping and exchange are key requirements for building more powerful energy simulations.

The method and system of this invention provides a virtual model system (VMS) framework that offers the innovative data collaboration, integration and sharing capabilities between CAD and software applications such as building code check, submission and compliance, energy performance simulation and prediction. This invention improves the traditional design process by, among other things, automating the acquisition of building materials and geometry via a computer. Output data of CAD drawing are desirably automatically formatted for direct import into an energy simulation tool, and then automatically converted into a ready to use graphic interface. The automation provided by this invention manipulates a program's object model and a database functionality enables the users to reuse and update the data through editors. The following are features and benefits of the method and system of this invention:
1. It builds on a systematic framework or platform of the building information model, which facilitates information sharing and data integration, and offers advanced building services through the use of tools in a collaborative project.
2. It offers data collaboration, integration, and sharing capabilities and allows seamless sharing and bidirectional reuse of data, thereby providing a new way to share information and collaborate on design data between applications through files, database, and software programs.
3. It enables quick updates and refines the design model relatively easily and more accurately, reducing design errors, cost, time, while speeding up project delivery.
4. It provides fully automated acquisition and expansion of building geometry through the commercial available computer aided design (CAD) object model.
5. It provides a mapping engine that translates the commercially available CAD model. Data extracted from a CAD model and drawings, such as geometries, coordinates, building materials and properties, are directly imported by the software of this invention. Data beyond the current capabilities of the CAD shared object model, such as local climate and weather data, building operating schedule, and HVAC systems, are obtained and stored in a database.
6. It provides an interactive and interfacing application for user-friendly graphical interface over the Internet.

The method and system of this invention are embodied as software on a recordable medium for execution by a computer. The software can be adapted to work with, or be bundle to existing CAD software and energy simulation software, or can be written into a full software package that includes CAD and energy simulation functionalities. The steps between the created CAD and the viewing of the energy simulation are desirably automatically done by the software, although the invention is not so limited as the software can allow for various user interaction throughout the system depending on need.

As used herein, references to “construction design” are to be understood to refer to any design or plan for use in constructing a structure, such as, but not limited to, a building.

Further, references herein to “computer aided design” or “CAD” are to be understood to generally refer to design in an electronic format readable by a computer, including two-dimensional drawings and three-dimensional design plans.

Other objects and advantages will be apparent to those skilled in the art from the following detailed description taken in conjunction with the appended claims and drawings.

### BRIEF DESCRIPTION OF THE DRAWINGS

FIG. 1 is a flow diagram of a software system according to one embodiment of this invention.

FIGS. 2-8 illustrate portions of building information model according to one embodiment of this invention. FIG. 2 is a building information model perspective view of a building and site. FIG. 3 is a perspective view of the first floor model of the building model shown in FIG. 2. FIG. 4 is a perspective view of the second floor model of the building model shown in FIG. 2. FIG. 5 is a perspective view of the roof model of the building model shown in FIG. 2. FIGS. 6 and 7 illustrate a model of the wall and floor construction, respectively, of a portion of the building model shown in FIG. 2. FIG. 8 is a perspective view of the window and door construction model of the building model shown in FIG. 2.

FIG. 9 is a perspective view of a building.

FIGS. 10A and 10B show building information models of the first and second floor layouts, respectively, of the building in FIG. 9.

FIG. 11 is a plan view of a data map of the thermal surfaces of the first floor of the building of FIG. 9.

FIG. 12 is a software window on a computer screen showing data mapping for wall construction and materials of a wall from the building of FIG. 9.

FIG. 13 is a software window on a computer screen data mapping for window construction and materials of a window from the building of FIG. 9.

FIGS. 14 and 15 are exemplary graphs from an energy efficiency analysis of one embodiment of this invention.

FIG. 16 is a flow diagram of a sustainable engine according to one embodiment of this invention.

### DETAILED DESCRIPTION OF THE INVENTION

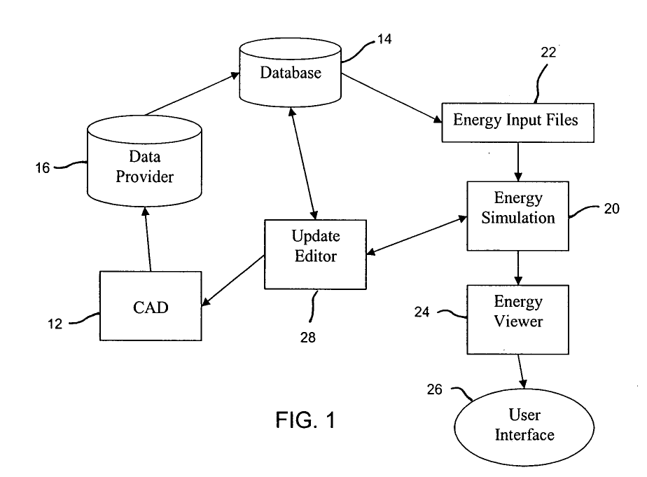

The computer automation provided by the method and system of this invention manipulates a construction design's object model, enables the users to reuse and update the data through editors, and translates building elements, geometries, coordinate, location, orientation, area, zone, and space for use in energy performance simulation. FIG. 1 is a flow diagram of a virtual model framework according to one embodiment of this invention. The method of this invention begins with an electronic construction plan, shown in FIG. 1 as a computer assisted design (CAD) 12. The electronic construction plan used in this invention can be any of various electronic designs, but is preferable a building information model, such as provided by currently available design software sold under the name Revit® from Autodesk, San Rafael, Calif.

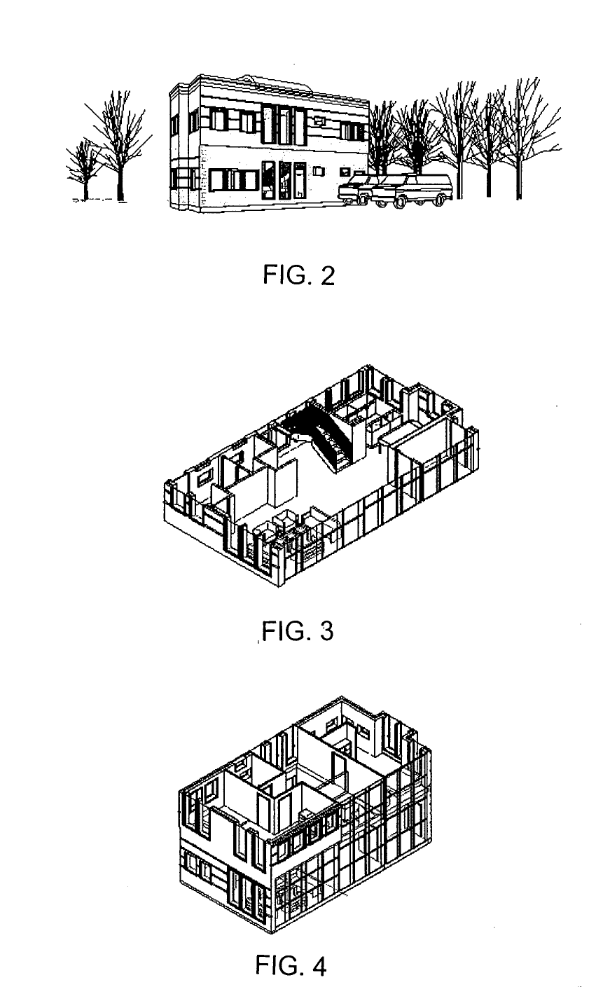

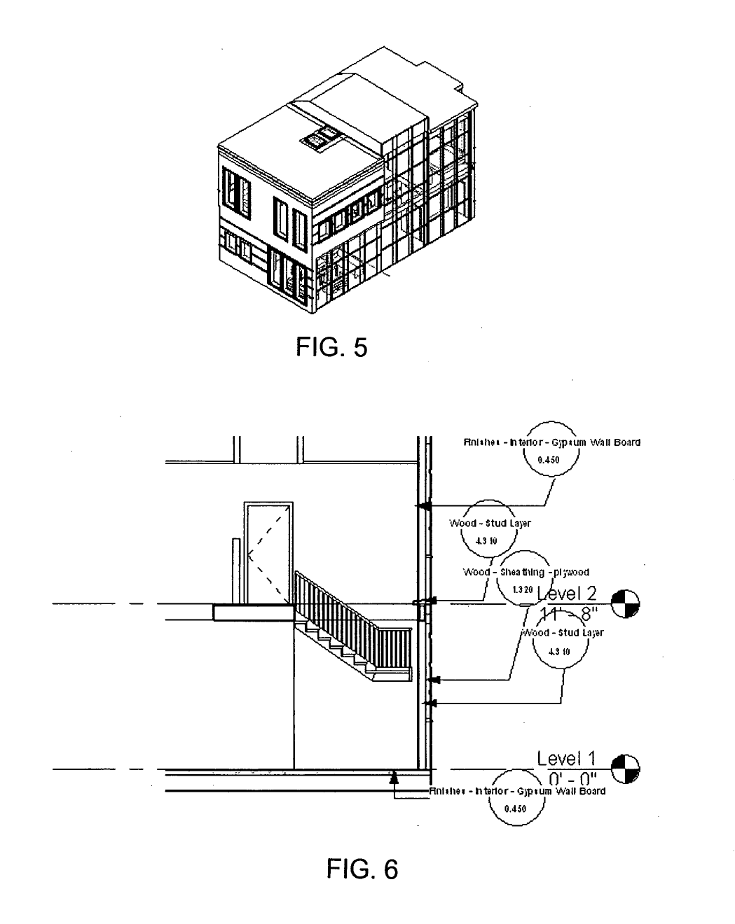

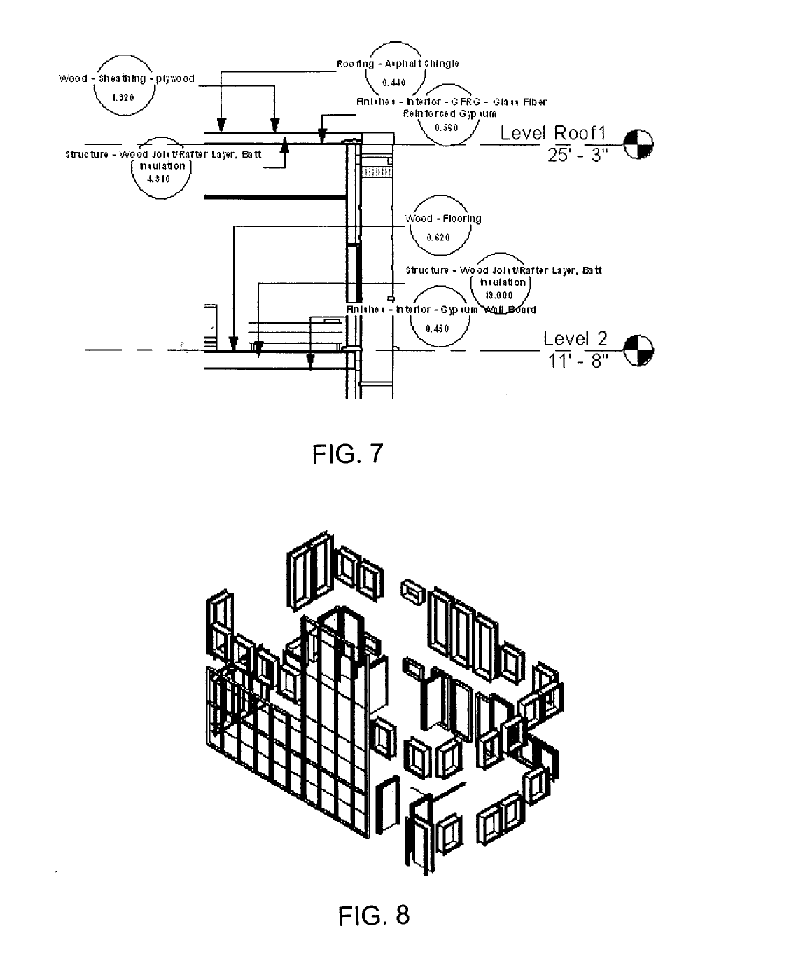

In one embodiment of this invention, where the original construction drawings are two-dimensional CAD drawings, these two-dimensional drawings must be transformed into an information model, such as shown in FIGS. 2-8, for further processing according to this invention. The two-dimensional drawings can be turned into a building information model three-dimensional CAD through creation of object representations for structural components in the two-dimensional drawings. Representations range from small objects, e.g., electrical outlets, doors, and lights, through full buildings and up to site or landscapes models, and support various phases of the design process. The resulting building information model includes geometric representations for information to be exchanged or shared, visualizations of the design process and/or the designed space, and also representations that integrate architectural design and the construction process, in order to create spatial high performance contexts for use in energy simulation. Revit® Architecture software is an example of current software that can be used to create building information models.

From the CAD 12, structure information, e.g., information about materials and dimensions, is extracted to a database 14. The database 14 is used to create a logical relationship between the structure information and the software for executing the energy simulation by constructing information that can be viewable and/or usable with various computers or computer applications being used. The database system of this invention provides for automated bidirectional data mapping, provides a standardization tool for use throughout building lifecycle, enhances workflow from data regeneration to interface and presentation, and captures resources and incorporates into a standard.

A data provider 16 serves as a bridge between the data source, here CAD 12, and the database 14, as well as other applications such as the energy simulator 20 discussed further below. The data provider 16 is used to retrieve data from the data source and, optionally, to reconcile changes to that data back to the data source. The data provider 16 provides functionality for connecting to the data source,

TABLE 1
Structural Information/Object Model Mapping Representations

| Member | | |
|---|---|---|
| Number | Member Name | Description |
| 1. | Building | Building gross area |
| | | Thermal zone area |
| | | Building perimeter |
| | | Building Level (Z coordinates) |
| 2. | Rooms or Space | Room name |
| | | Room area and volume |
| | | Room perimeter |
| | | Room level (Z coordinates) |
| | | Daylight and artificial lights conditions |
| 3. | Floor | Floor area and volume |
| | | Floor perimeter |
| | | Floor level (Z coordinates) |
| | | Floor construction and materials |
| 4. | Ceiling | Ceiling area and volume |
| | | Ceiling perimeter |
| | | Ceiling level (Z coordinates) |
| | | Ceiling construction and materials |
| 5. | Roof | Roof area and volume |
| | | Roof perimeter |
| | | Roof base level (Z coordinates) |
| | | Roof construction and materials |
| 6. | Wall | Wall callout number |
| | | Wall width, length and height |
| | | Wall perimeter |
| | | Wall construction and materials |
| 7. | Window | Window callout number |
| | | Window width, and height |
| | | Window head height-sill height |
| | | Window construction and materials |
| 8. | Door | Door callout number |
| | | Door width, and height |
| | | Door head height-sill height |
| | | Door construction and materials |
| 9. | Interior Wall | Wall callout number |
| | | Wall width, length and height |
| | | Wall perimeter |
| | | Wall construction and materials |
| 10. | Zone condition | Lights (DOE-2 added schedule) |
| | | Occupancy (DOE-2 added schedule) |
| | | Equipment (DOE-2 added schedule) |

In one embodiment of this invention, a data binding functionality creates a data relationship between the structural information obtained from the CAD 12. This data relationship links some or all of the structural components of the structural information together. This relationship is beneficial in that it allows the energy simulation engine or other application to see another project's dataset when searching for one dataset.

The method and system of this invention provide for an automated interface for data mapping and exchange between the CAD 12, for example a Revit® building model, and an energy simulation 20, such as a thermal-based DOE-2 energy simulation model. The structure information extraction functionality of this invention reads and extracts coordinates, geometries, thermal zones, and construction and material properties from the CAD 12 and translates it to create one or more DOE-2 input files 22 in order to perform an energy simulation.

The extraction of structural information, e.g., data embedded in objects in the CAD 12, generates a structure component list of floors, space, zones, walls, interior walls, roof, windows, doors, ceilings, etc., as well as building construction materials and thermal objects, i.e., zones and surfaces. Building geometry is also included as it is typically essential to energy simulation engines such as DOE-2. The method and system of this invention improves the usability of DOE-2 performance simulation due to the full capacity of acquiring bidirectional information.

Once input file(s) 22, e.g., an ASCII input file, is created from the structure component list of the structure information, the software system calls and queries the DOE-2 energy simulation model 20 as an operating command engine. The querying provides the necessary structural information to the DOE-2 energy simulation model 20, based upon software requirements, for calculating the heating cooling, and lighting loads necessary to maintain thermal and daylight control set points and conditions throughout the secondary HVAC system and coil loads, and the energy consumption of primary plant equipment as well as many other simulation details that are necessary to verify that the simulation is performing as the actual building would. As a simplified example of a query, the software may ask for the number and types of lighting fixtures in a given room, or the entire building.

The energy efficiency analysis of the construction plan provided by the energy simulation is desirably sent to a web browser by an energy viewer 24 for displaying through a user interface 26, e.g., a computer screen. The energy viewer 24, which can be integrated with the energy simulator software 20, desirably places the energy efficiency analysis into the desired readable format, such as a graphical representation. Benefits of using a web browser graphic interface includes enabling designers and building professional to collaborate, share, and improve the relationships of building parametric elements and systems that affect energy efficiency and sustainability of a building design on the Internet. Energy performances are desirably displayed in well-defined graphical forms. The graphical forms can effectively communicate, link, and apply information, test options, compare the scenarios, make quick decisions, and determine the most efficient solutions. As a result, environmentally friendly and sustainability alternatives can be explored and better solutions for complex energy problems can be developed.

In one embodiment of this invention, a data bidirectional functionality allows for a user to alter the energy simulation with a different structural information, e.g., substituting an alternative structural component for comparison purposes. Once the alternative structural component, for example, a different type of heat source, lighting type (florescent versus halogen; and/or wattage differences), or room layout, has been entered by the user through the interface 26, the energy simulator 20 executes a second energy simulation using the alternative structural component that is substituted in place of the original structural component to obtain a second energy efficiency analysis. The user interface 26 displays the second energy efficiency analysis through the user interface 26. The user can compare the second energy efficiency analysis to the original energy efficiency analysis. If the second energy efficiency analysis is preferred, the user can enter a command to update the electronic construction plan through a user command. An update editor 28 operates to update the database 14 and the CAD 12 to implement the alternative structural components. As will be appreciated by those skilled in the art following the teachings herein provided, this aspect of the invention is described in a simplified manner for explanatory purposes. The user(s) of the method and system of this invention will likely run multiple alternatives in the energy simulator 20, such as described below.

In one embodiment of this invention, material prices of the structural components or materials used to make components, such as lumber, steel, and concrete, are imported into the database 14. The material prices can be used to provide the user with the projected product cost, as well as the energy performance, by applying material prices to the structure component list, thereby allowing for the balancing of costs.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

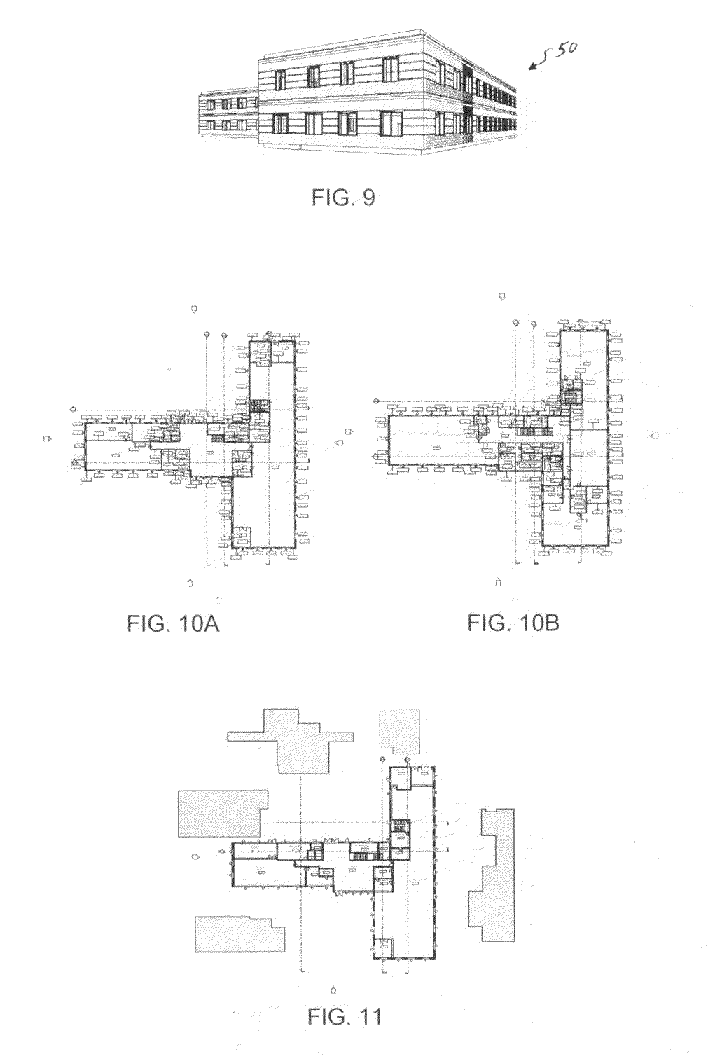

To further explain and demonstrate this invention, the method and system will be applied to the computer aided design (CAD) of the building 50 shown in FIG. 9.

Building site information is provided to the system software, desirably by inclusion in the CAD for building 50. The site represents an area, and can include one or more building. The site information includes, without limitation, the project site layout, location, climate location, and weather data to match with the desired energy simulation weather data. Project site data provided for DOE-2 typically includes site latitude, longitude, altitude, time zone, and necessary weather data. In one embodiment of this invention, environmental information, such as climate and weather data, for example, the average daily temperature for a yearlong period, is obtained from sources outside of the electronic construction plan. This information is desirable imported into the database for use in the energy simulation.

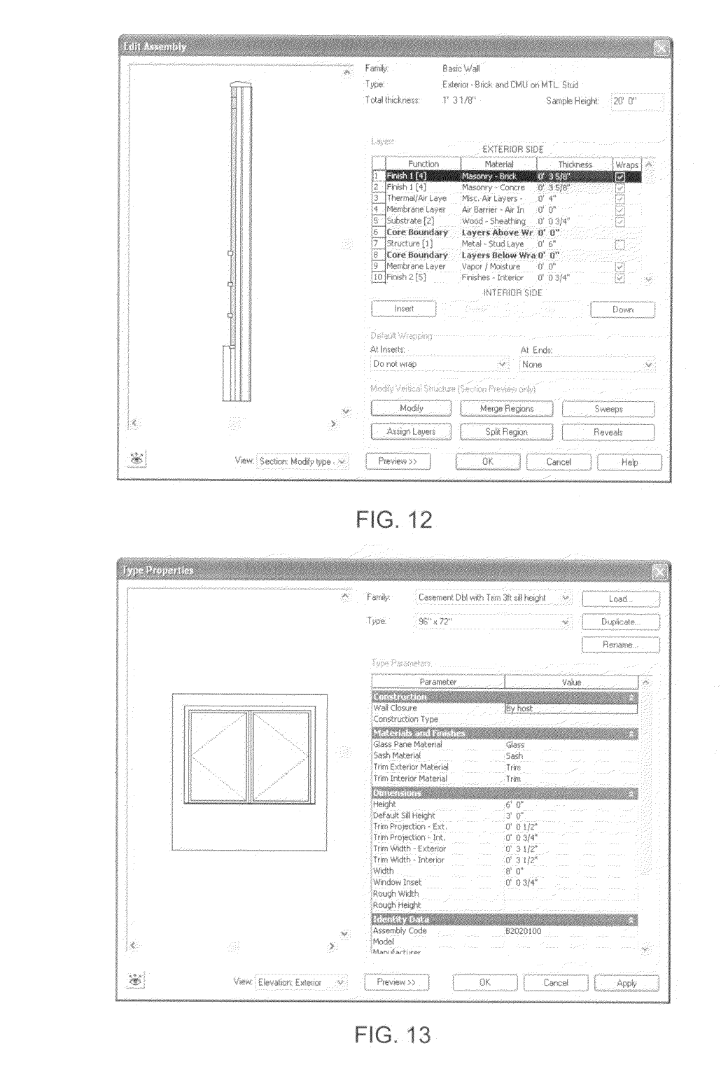

FIGS. 10A and 10B represent the first and second floor layout, respectively, of the building 50. The data mapping engine of this invention provides full capability for data extraction from CAD drawings and three dimensional drawing models, such as shown by FIGS. 10A and 10B. Data extraction of structural information according to this invention is performed by object modeling, where each structural component is extracted and represented in a component list (including size and construction materials) of the database. For example, FIG. 12 illustrates a computer screen showing data mapping for wall construction and materials and FIG. 13 illustrates a computer screen showing data mapping for window construction and materials. As seen in FIG. 12, the structural information provided by the data mapping of this wall as an object representation includes construction information such as a wood skeletal substrate and a concrete finish, along with thickness measurements of each. Similarly, the window object of FIG. 13 identifies single glass pane and dimensions includes height, inset, and trim width and projection.

In addition to materials and components, geometric representations of the objects in the CAD are also mapped and represented in the structural information of the database. The building 50 includes two stories. A building envelope of building 50 includes the building level, area, area schemes, space or rooms, and thermal zones. The building level includes an elevation and represents a horizontal aggregation of space (rooms) that are vertically bound. The building area consists of area measurements and area schemes, which are desirably defined by color-fill diagrams depicting function by programmatic area, with real-time, automatically generated area tabulations. Rooms, or spaces, represent areas or volumes bounded by surfaces. The geometric representation of rooms or space is given by shape and placement allowing multiple geometric representations.

Building 50 includes exterior walls and interior walls. Walls are defined with certain constraints for the provision of parameters and geometric representation. The geometric representation of each wall is given by shape and placement, allowing for multiple geometric representations. Windows represent openings or recesses, and reflect voids. There are at least two types of “windows”, i.e., openings and recesses or niches, which are both defined by attributes of the object. Windows have to be inserted into a wall element, which is part of the building elements and has the element relationship.

Doors are defined as opening elements, which are inserted into a wall element and become part of the building elements and have the element relationship. The components that enclose a room or space vertically include a lower support (floor), upper support in the room (ceiling), and/or upper construction in the building (roof).

A model, e.g., a BIM, according to this invention is a representation of computer aided design information and how the information relates to other information, such as energy efficiency analysis and simulation like DOE-2. A model of computer aided design information is an object model; while a model of energy efficiency analysis and simulation information is a process model. An object model represents the information and structure of an object and its underlying structural components, which also are objects. A process model represents the information and structure of a workflow and its underlying processes.

Here, the invention uses DOE2.1E as the energy simulation engine. The system needs to extract the structural information and prepare it in the format required by the DOE2.1E input data file. The fundamental requirements for performing energy efficiency analysis and simulation with DOE-2 include:
1. Climate and weather data, which describes the design climate and location for the site (city) where the building is situated (the weather period is normally one year);
2. Building operating schedule, which describes building use information to allow specification of the number of people, lighting, and equipment (either electric, gas, or other fuel types) in each thermal zones;
3. Space and zone conditions, such as artificial lighting object representations of lighting types, quantities, power generated, the location of each room or architectural space in the building, building thermostatic condition control schedule, which describe temperature control, and the thermal zone condition in each zone of the building;
4. Geometric representation of the thermal zones and enclosure of heat transfer surfaces for each thermal zone. A thermal zone defines a thermal instead of architectural space, which is the basic information of simulation. The geometric representations of thermal zones may or may not be identical to architectural space in the CAD drawing. For each of thermal zone, information regarding enclosure of heat transfer surfaces need to be obtained. A thermal zone requires parametric information of zone north axis, origin, type, ceiling height, zone volume, and convection algorithm;
5. Geometric representation of the thermal surfaces, which converts from building elements such as walls, windows, doors, floors, ceilings, and roofs. Thermal surfaces refer to heat transfer surfaces to describe the thermal representations of building elements, such as walls, roof, windows, doors, ceiling, and floor. Each surface has some attributes to determine its interaction between internal and external environment. A surface may have interaction with another surface to represent inter zone heat transfer. Thermal surfaces are generally the basic ingredients of the thermal simulation.
6. Physical construction and thermal material properties of building elements, which describe specification of building geometry and surface materials and constructions;
7. Building use information, to allow specification of the lighting and equipment (electric, gas, or other fuel), people in the building;
8. HVAC system information, to allow specification and scheduling of the system;
9. Plant system information, to allow specification and scheduling of the system;
10. Economics of energy saving system information, to allow specification and scheduling of the system; and
11. Thermal design parameters, for specifying the intended simulation settings.

FIG. 11 illustrates an embodiment of data mapping of the thermal surfaces of the first floor of building 50. The database server also provides for mapping of artificial lighting as object representations, including lighting type, quantities, power generation, and location in each room or architectural space in the building.

In one embodiment of this invention, the system includes a thermal design software engine that simulates the exchanges of heat through the outer skin of the building, and shows yearly estimates for the required heating and cooling energy, heat gain, and heat loss through building components. The software provides the building energy performance and amount of energy electricity consumption (Kwh) and gas (Therm). Energy consumption includes lighting, equipment, space heating, space cooling, pump, and fan.

In order to accurately calculate the energy efficiency, the amount of day light must be known in addition to the size and placement of the windows of the building 50. In one embodiment, the system predicts the distribution of sunlight in a room, according to time of day and location, and calculates a yearlong average of the amount of daylight projected onto a work surface in the room. The system offers an estimate of the amount of electrical lighting energy required to make up for the lack of natural daylight in certain areas of the room. As the software retains weather data for every hour of the year, for at least the city where a user may situate the building 50, modules are run on an hourly basis. Daylight factor results are plotted for each executing commands, and retrieving results. Those results can be processed directly, or placed in a dataset for further processing while in a disconnected state. The data provider 16 of this embodiment of this invention extracts and retrieves data from the building design and provides full data exchange bidirectional capabilities between three-dimensional building models, two-dimensional design drawings (if any), construction documents and specifications, and energy analysis programs.

The data provider 16 desirably provides a data mapping functionality to map the geometric (e.g., dimensions) and non-geometric (e.g., components and materials) information from the CAD 12 and store this information as the extracted structural information in the database 14. Data mapping allows for establishing a correspondence between data in CAD 12 and the data provider 14. Table 1 show a simplified example of the object model representations in a structure component list that can be obtained from the CAD 12 as structural information using a data mapping engine in the framework of FIG. 1.

combination of window and reference point in a daylight space. The software interface provides daylight information for space, window, and reference point. In one embodiment, a daylight factor is calculated by a preprocessor for twenty values of solar altitude and azimuth covering the annual range of sun position at the location being analyzed. The software projects the results on a space working plane between the elevation and floor plan. The window's size, shape, and position are reflected from the CAD drawings and be able to updated both at the source or the interface program through editor.

Using the CAD construction plan, the software system of this invention provides an energy efficiency analysis. The followings are the basic descriptions of exemplary base line properties for building 50:
1. Indoor ventilation used purely mechanical system. The building has well-mixed indoor air flow and air infiltration.
2. Walls materials have R-11 insulation.
3. Windows used single glazed clear glass without blind.
4. Windows area is approximately 60% of the room wall area that windows take up.
5. Occupancy loads=143 people/sq.ft.
6. Lighting requirements=1.3 watts/sq.ft.
7. Equipment loads=0.7 watts/sq.ft
8. HVAC system and equipments were typical fan coil units to cool the zones and space.

The following energy efficiency analysis provides the energy consumed in kilowatts-hours (kWh) for a whole year:

1. Space Lighting=133,109 kWh

2. Equipment=48,393 kWh

3. Space Heating=5,929 kWh

4. Space Cooling=44,095 kWh

5. Fan Energy=125,021 kWh

6. Pump Energy=49,060 kWh

A second energy efficiency analysis can be done for comparison purposes by substituting, in this example, a ground loop heat pump for the use of typical fan coil units. As seen below, by making this substitution, fan and pump energy consumptions were reduced drastically with the same level of comfort. The reason that the space heating energy is higher is due to the fact that typical fan coil units consumed both electricity and gas energy, but ground loop heat pump consumed only electricity energy.

1. Space Lighting=133,109 kWh

2. Equipment=48,393 kWh

3. Space Heating=19,032 kWh

4. Space Cooling=44,021 kWh

5. Fan Energy=36,234 kWh

6. Pump Energy=29,754 kWh

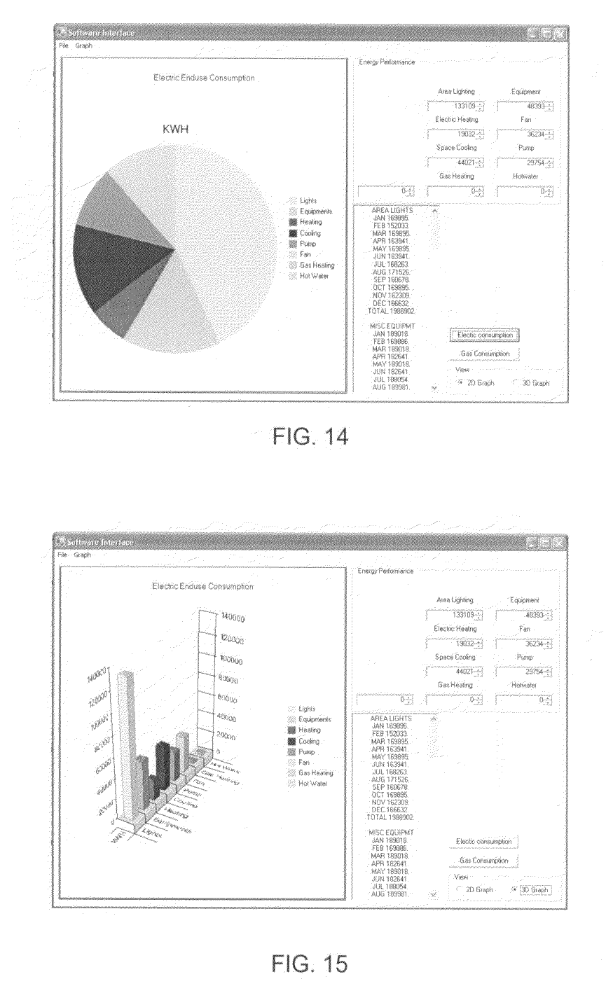

FIGS. 14 and 15 illustrate graphical representations of the results for displaying on a user interface for consideration by the system user.

As another example, a third energy efficiency analysis is obtained for a scenario replacing the single clear glass with low-E, double glazed glass types. With this substitution, space heating and lighting energy were reduced.

1. Space Lighting=110,823 kWh

2. Equipment=48,393 kWh

3. Space Heating=13,156 kWh

4. Space Cooling=45,945 kWh

5. Fan Energy=35,575 kWh

6. Pump Energy=29,252 kWh

A further scenario was analyzed with the idea that day lighting can help not only in energy efficiency, but also the human comfort and space quality. This fourth scenario substituted daylight for the electric lights in the building and reduced the energy consumptions.

1. Space Lighting=84,982 kWh

2. Equipment=48,393 kWh

3. Space Heating=14,270 kWh

4. Space Cooling=44,574 kWh

5. Fan Energy=35,224 kWh

6. Pump Energy=28,913 kWh

A fifth scenario installed blinds for all South and West facing windows and overhangs on the South facing façade in order to study the effects of these shading devices, while preserving the human comfort from glare effect. In this scenario, space cooling and heating energy consumptions were slightly reduced.

1. Space Lighting=84,982 kWh

2. Equipment=48,393 kWh

3. Space Heating=13,645 kWh

4. Space Cooling=36,141 kWh

5. Fan Energy=35,224 kWh

6. Pump Energy=28,913 kWh

Thus, the invention provides a unique AEC collaboration technology allowing full interoperability through shared information models and data modeling. This invention answers the need for data interoperability and technological challenge to fully and bidirectional data sharing, updating, and reusing by providing the ability to link and share object-based model in CAD with performance-based model in energy simulation. Particular benefits of the method and system of this invention are the significant reduced time and effort spent in creating energy efficient building and sustainable design.

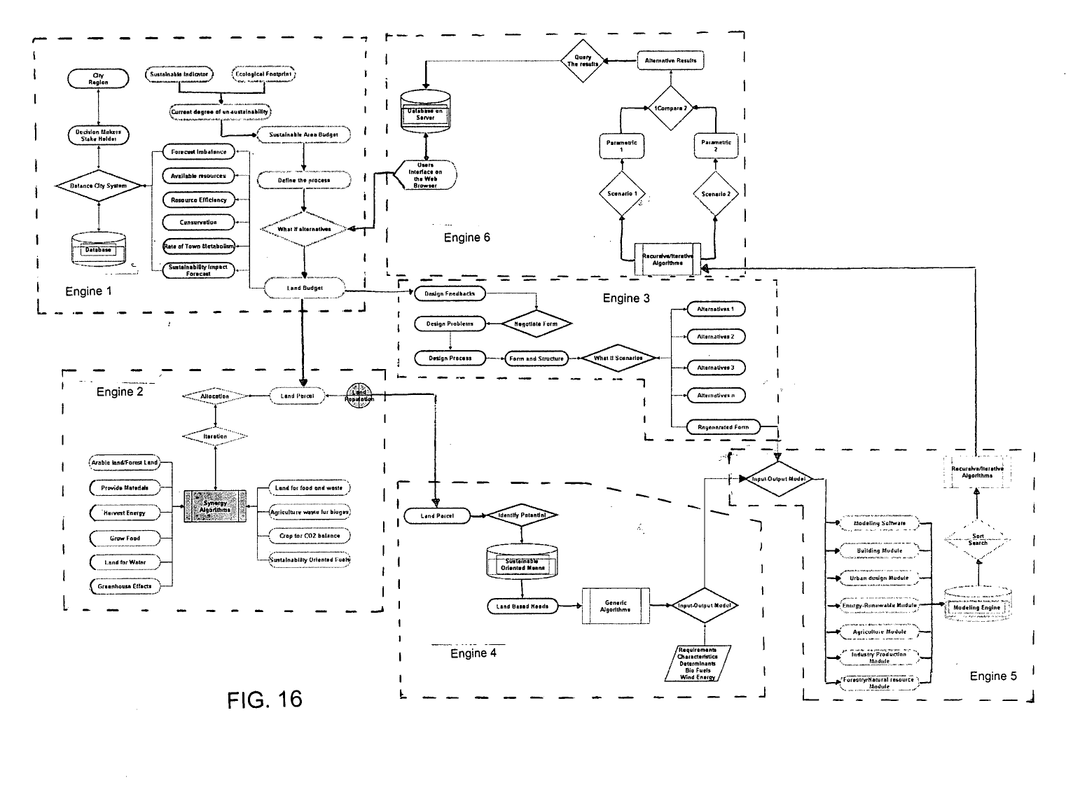

In another embodiment of this invention, the method of this invention is applied to a community, e.g., a plurality of buildings in a land area, instead of only a single building. FIG. 16 is a flow diagram of a sustainable engine for the purpose of constructing a sustainable design for use in balancing resource demands with resource supplies. Sustainable design (also sometimes referred to as “green design”, “eco-design”, or “design for environment”) is the art of designing physical objects to comply with the principles of economic, social, and ecological sustainability. The essential aim of sustainable design is to produce places, products, and services in a way that reduces use of non-renewable resources, minimizes environmental impact, and relates people with the natural environment. Sustainable design is often viewed as a necessary tool for achieving sustainability.

The sustainable engine of this invention is constructed from looping network algorithms and the relationship of many elements. Elements in the sustainable design are defined as object-noun (e.g., land, building, food, materials, forest, water, wind, daylight, trees agriculture produces, biomass etc.), event-verb (e.g., human activities, ecological balance, import goods), or event driven procedure, (e.g., energy, ecology, sustainability, human cognition). Once the design and planning elements are assigned as objects, events, and event driven procedures, all of the elements and their associative would are generated into graphical and non-graphical data, quantitative and qualitative models, and/or relationship elements. These models can then be linked, exchanged, reused, related, and interact with one another in energy efficient, ecological balance, and sustainable models.

The sustainable engine of FIG. 16 can be divided into six engine functionalities. In Engine 1, a sustainable area budget (SAB) is defined to provide a fixed land budget within which sustainability imbalances are to be negotiated at the beginning of a project and compared with indicator and foot print methods. In order for decision makers and stakeholders of a city/region to have a clearer understanding of their available resources, the land budget will be queried through a loop to find criteria that matches the query. The software can forecast the potential balances and react to them through the entire design process. A database is designed to make the query process faster and more efficient. The inner metabolism will also be modeled and adjusted through a Balance City System Programming, with all energy and material flows are continually rebalanced, so that the major flow processes are organized into regenerative loops and no waste or harmful imbalances are produced.

Although the SAB is programmed based on land area divided by its population, there are also a number of Sustainability Oriented Energy sources that are included in the major models (bio-fuels, sewage to methane, agricultural wastes, wind etc.). Thus, Engine 2 includes Synergy Algorithms that work with Iteration and Allocation Algorithms to perform loop simulation of land area, arable land (e.g., grow food, harvest energy, and obtain materials to build and live), forest land (e.g., tree crops, CO₂ sequestration and for its value as nature), the integration of such input/output/general requirements/characteristic determinants (e.g., bio-fuel energy productivity per area in relation to soil types, water and hydrology, organic soil amendment, labor requirements, mechanization, local farming practices, slopes, orientation, growing season, etc.) Some of these determinants would themselves be linked to other free body determinants. Some initial assumptions concerning determinants may prove to be trivial and would drop out of subsequent operations, while some critical determinants may be discovered to have been neglected and would therefore be integrated into later operations.

In Engine 3, design problems and feedback processes inform what is to be done with this budgeted land area through design and planning processes. In a process to design a new city, for example, there will be many different interests to satisfy and many powers to be assuaged. Because the processes of synthesizing the sustainable city are complex, Negotiate Form Algorithms are used to simulate the design problems, and “What If Scenarios” Algorithms simulate design alternatives and testing the regenerative forms. Each scenario has different characteristics, strengths, and weaknesses. In subsequent rounds of play, ideas with favorable consequences from one scenario will find their way into other scenarios, and through successive iterations of the simulation, the models will become more complex, more responsive, more diverse, and more resilient, and the surviving ones will all be approaching balance. Each stakeholder will find his/her interests represented in several or all of the emerging scenarios as new ideas emerge through the process and one scenario tends to be folded into the others.

In Engine 4, in order to identify a specific area or a choice of land parcels available for working as different parcels that will have different potentials, a database of Sustainability Oriented Means is included to provide the town model with its land based needs. Generative algorithms act as “free body” or “any body” intelligent energy modeling programs to facilitate performance. Generative algorithms drive the Input and Output Model which contain data integration of such input/output/general requirements/characteristic determinants.

The Input and Output Model Algorithms of Engine 5 help identity which urban planning modules and software will be used for appropriate tasks. The modules and software are stored inside the Modeling Engine. The Modeling Engine uses Sort and Search Algorithms to select appropriate modules or software to model and simulate the scenarios. The database of the urban module library is desirably built inside the Modeling Engine.

In Engine 6, Recursive and Iterative Algorithms are used to designate the way to simulate the scenarios, which can rapidly provide a physical model of a whole city. Through a series of recursive or iterative algorithms, the system maps both quantitative and qualitative data. A user interface on a web browser provides the interactive environment that assembles scenarios of already sustainability process, and displays the alternative design. It has two capabilities that work simultaneously and interactively with the users: one is its input forms which will assemble the feedbacks from architects, engineers, and other technicians and the needs, desires and interests of the various stakeholder groups—the people who are to work and live in the town are being met or responded to; and the other is its display the results as graphics, spreadsheets, charts, texts, and tables based on needs, desires, and interests. The role of sustainable city design and the role of scenario building as a research method for projecting alternative futures encompasses what may be considered to be the least desirable to the most desirable and from the most unsustainable to the least unsustainable.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of improving construction design, comprising:
preparing an electronic construction plan;
extracting structure information from the electronic construction plan;
executing an energy simulation using at least a portion of the structure information; and
displaying an energy efficiency analysis of the construction plan through a user interface.

2. The method of claim 1, wherein preparing an electronic construction plan comprises providing a building information model with computer aided design software on a recordable medium.

3. The method of claim 1, further comprising creating a logical relationship between the structure information and software on the recordable medium for executing the energy simulation.

4. The method of claim 3, further comprising creating an ASCII input file from the extracted structure information.

5. The method of claim 3, wherein executing the energy simulation comprises creating a graphical representation from the ASCII input file and wherein the graphical representation is displayed as at least a portion of the energy efficiency analysis.

6. The method of claim 1, wherein extracting the structure information from the computer aided design software comprises creating a structure component list stored in a database.

7. The method of claim 6, further comprising querying the structure component list to obtain information needed for executing the energy simulation.

8. The method of claim 6, further comprising importing at least one of environmental information and material prices into the database.

9. The method of claim 6, further comprising querying the structure component list and the at least one of the environmental information and the material prices.

10. The method of claim 1, further comprising projecting project costs by applying material prices to the structure component list.

11. The method of claim 1, wherein the construction design is for a plurality of buildings in a land area, and further comprising balancing a resource demand with a resource supply.

12. The method of claim 6, further comprising:
executing a second energy simulation using an alternative structural component in place of a structural component of the structural component list to obtain a second energy efficiency analysis;
displaying the second energy efficiency analysis through the user interface; and
updating the electronic construction plan by command of a user if the second energy efficiency analysis is preferred over the energy efficiency analysis.

13. The method of claim 1, wherein each step is performed via software on a computer-readable medium.

14. A method of improving construction design, comprising:
providing an electronic construction plan;
extracting structure information from the electronic construction plan, the structural information including an electronic list of structural components;
executing a first energy simulation as a function of at least a portion of the structure components;
displaying an energy efficiency analysis from the first energy simulation through a user interface;
receiving an alternative structural component through the user interface, wherein the alternative structural component is used as a substitute for at least one structural component of the list of structural components;
executing a second energy simulation using the alternative structural component instead of the at least one structural component; and
displaying through the user interface a second energy efficiency analysis from the second energy simulation for comparison by a user to the first energy efficiency analysis.

15. The method of claim 14, further comprising altering the electronic construction plan to include the alternative structural component.

16. The method of claim 14, further comprising querying the electronic list of structural components to obtain information needed for executing the first energy simulation.

17. The method of claim 14, wherein the electronic list of structural components is compiled in a database and further comprising importing at least one of environmental information and material prices into the database.

18. The method of claim 17, further comprising querying the electronic list of structural components and the at least one of the environmental information and the material prices to obtain information needed for executing the first energy simulation.

19. The method of claim 17, further comprising projecting project costs by applying the material prices to the list of structural components.

20. The method of claim 14, wherein each step is performed via a computer.
